(19) United States
(12) Patent Application Publication
(10) Pub. No.: US 2019/0371217 A1
(43) Pub. Date: Dec. 5, 2019

(54) DISPLAY APPARATUS

(71) Applicant: Kino-Mo Ltd., London (GB)

(72) Inventors: KIRYL CHYKEYUK, London (GB); DZMITRY MALINOUSKI, London (GB); ARTSIOM STAVENKA, London (GB)

(21) Appl. No.: 16/446,442

(22) Filed: Jun. 19, 2019

Related U.S. Application Data
(63) Continuation of application No. 15/128,047, filed on Sep. 21, 2016, now abandoned.

(30) Foreign Application Priority Data
Mar. 21, 2014 (GB) 1405107.2
Dec. 4, 2014 (GB) 1421609.7

(51) Int. Cl. G09G 3/00; B62J 6/20

(52) U.S. Cl. CPC G09G 3/001; G09G 2300/04; B62J 6/20

(57) ABSTRACT

A persistence of vision display is disclosed comprising: a processing unit; a plurality of light arrays in dependently electrically connected to said processing unit, wherein the processing unit is adapted to control the output displayed on each array independently.

### RELATED APPLICATIONS

The present application is a continuation of U.S. patent application Ser. No. 15/128,047 filed Sep. 21, 2016 with a docket number of 3118-033.PCT.US, which claims priority to International Application No. PCT/GB2015/050843 filed Mar. 20, 2015; which claims priority to U.K. Patent Application No. 1421609.7 filed Dec. 4, 2014 and U.K. Patent Application No. 1405107.2 filed Mar. 21, 2014, the entire specifications of which are hereby incorporated by reference in their entirety for all purposes.

### FIELD OF INVENTION

This invention relates to a display apparatus. In particular this invention relates to a persistence of vision display apparatus.

### BACKGROUND

Persistence of vision is a phenomenon whereby a succession of images is perceived by the brain as forming a moving image. Applications of such an effect include flip-book cartoons and film systems. Other applications include creating a two dimensional image by rapidly moving a one dimensional image along a line or circular path, for example a Catherine wheel firework being perceived as a circular image.

A specific application of this phenomenon has been used to display a stationary or moving image on a rotating wheel; an example of such a device is described in WO2013/122602 in the name of Goldwater. This shows a device comprising four connected light arrays which are attached to the spokes of a bicycle wheel. As the wheel rotates, sensors on the light arrays determine their position and illuminate accordingly; if the speed of rotation is sufficient to trigger persistence of vision, an image is perceived to be displayed on the bicycle wheel. The point at which a suitable level of persistence of vision is perceived is generally around 10 frames per second. In the example of a rotating wheel the frame rate is effectively the number of times a particular point is passed by any of the light arrays per second and thus is dependent on not only the speed of rotation of the wheel but also on the number of light arrays; in the prior art; which is constrained to using four arrays, this corresponds to approximately 2.5 rotations per second, which requires a bicycle with a wheel diameter of 670 mm to be moving at a speed of approximately 19 kilometres per hour. This speed may be too fast for a stationary viewer to be able to appreciate the display.

The prior art employs an electrical bus structure so as to facilitate the control of the device, however this means that if a single array fails or becomes detached, the entire device stops operating.

Further characteristics of persistence of vision displays include resolution and representation of colour on the display. In the example of a rotating wheel, these are determined by the number of individual light emitting elements on each array and the range of colours able to be displayed. The prior art system is limited in both these regards by space requirements and processing power required to control a large number of individual elements with little latency.

An improved display is therefore required which at least alleviates some of the aforementioned disadvantages.

According to one aspect of the invention there is provided a persistence of vision display comprising a processing unit; a plurality of light arrays each independently electrically connected to said processing unit, wherein the processing unit is adapted to control the output displayed on each array independently.

Preferably, the light arrays are adapted to be moved so as to generate a persistence of vision image; preferably wherein the movement is a rotational movement.

Preferably, the processing unit is adapted to control the output displayed on each array by providing data and/or instructions to each array.

Preferably, the processing unit comprises a real time computational module; and wherein the computational module is adapted to control the operation of one or more light arrays in real-time.

Preferably, the real time computational module is in the form of a Field-Programmable Gate Array (FPGA).

Preferably, the processing unit further comprises a central processor which provides data and/or instructions to the computational module.

Preferably, the central processor comprises the computational module.

Preferably, each light array is independently mechanically connected to the processing unit.

Preferably, the electrical connection between each light array and the processing unit is provided by means of a ribbon cable.

Preferably, each light array is independently powered.

Preferably, each light array comprises means for holding a battery.

Preferably, each light array is operable to share a power source with another light array.

Preferably, when in use, the two light arrays operable to share a power source are configured to be positioned on opposing sides of a wheel.

Preferably, the processing unit is shaped and dimensioned so as to be positioned in between spokes on opposing faces of a wheel.

Preferably, the processing unit is shaped and dimensioned so as to fit around a hub of a wheel, and preferably wherein the processing unit is horseshoe shaped.

Preferably, the processing unit is shaped so as to substantially conform to a regular polygon.

Preferably, the device comprises means for detecting the speed of rotation of the device.

Preferably, the means for detecting the speed of rotation of the device comprises a magnetic sensor on the processing unit.

Preferably, the means for detecting the speed of rotation of the device comprises a magnetic sensor on one or more of said light arrays.

Preferably, the output of the speed unit is passed to the processing unit to determine the angular speed of the device.

Preferably, the output of the speed unit is passed to the computational module to determine the angular speed of the device.

Preferably, the processing unit is operable to activate the device when the rotational speed exceeds a pre-determined threshold.

Preferably, the processing unit is operable to deactivate the device when the rotational speed is below a pre-determined threshold.

Preferably, the processing unit comprises means for detecting the orientation of the device.

Preferably, the means for detecting the orientation of the device comprises an accelerometer positioned on the processing unit.

Preferably, the means for detecting the orientation of the device comprises a magnetic sensor positioned on one or more of said light arrays.

Preferably, the means for detecting the orientation of the device comprises a magnetic sensor positioned on the processing unit.

Preferably, the output of the orientation unit is passed to the processing unit to determine the position of one or more arrays.

Preferably, the output of the orientation unit is passed to the computational module to determine the position of one or more arrays.

Preferably, the processing unit comprises a separate control board comprising said central processor and at least one processing board to which said computational module is mounted.

Preferably, the processing unit comprises two processing boards, each provided with a real time computational module.

Preferably, each processing board is operable to control a plurality of light arrays.

Preferably, each processing board is operable to control between 2 and 64, preferably between 4 and 32 light arrays, and preferably 8 or 16 light arrays.

Preferably, the control board comprises connections for providing mechanical connections to said processing boards so as to be positioned between the two processing boards.

Preferably, the light arrays are adapted to be secured to a wheel.

According to a further aspect of the invention there is provided a wheel comprising the device as described herein.

According to another aspect of the invention there is provided a bicycle comprising a wheel as described herein.

Preferably, the device further comprises a motor adapted to rotate said light arrays.

Preferably, the device further comprises a slip ring adapted to provide power to said light arrays.

Preferably, the device further comprises a slip ring adapted to provide a control signal to said light arrays.

Preferably, each light array comprises two or more groups of illuminable elements, each group being independently electrically connected to said processing unit.

Preferably, each group of illuminable elements correspond to a longitudinally connected light array.

Preferably, a light array adapted to be positioned around a centre of rotation of the device.

Preferably, the light array is adapted to be positioned around a centre of rotation of the device is adapted to be mechanically attached to said plurality of light arrays.

Preferably, the light array is adapted to be positioned around a centre of rotation of the device is shaped to conform to the shape of the persistence of vision device.

Preferably, the light array is adapted to be positioned around a centre of rotation of the device comprises substantially the same number of arms as there are light arrays.

Preferably, the plurality of light arrays are shaped so as to tessellate at the centre of rotation of the device.

According to yet a further aspect of the invention there is provided a light array for a persistence of vision display comprising: a plurality of illuminable elements arranged in an array; a connector adjacent to a first end of the array for electrically connecting the array to a processing unit; means for mechanically connecting the array to a spoke; wherein the means for connecting the array to a spoke comprises a plurality of apertures provided adjacent to a second end of the array.

Preferably, the plurality of apertures provided adjacent to the second end of the array are arranged in a transverse direction to the major axis of the array.

Preferably, the light array further comprises means for mechanically connecting the array to a further array adapted to be provided on an opposite face of a wheel.

Preferably, the light array further comprises a means for holding a battery.

Preferably, each light array is operable to share a power source with another light array.

The invention extends to any novel aspects or features described and/or illustrated herein.

Further features of the invention are characterised by the other independent and dependent claims

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

The invention also provides a computer program and a computer program product comprising software code adapted, when executed on a data processing apparatus, to perform any of the methods described herein, including any or all of their component steps.

The invention also provides a computer program and a computer program product comprising software code which, when executed on a data processing apparatus, comprises any of the apparatus features described herein.

The invention also provides a computer program and a computer program product having an operating system which supports a computer program for carrying out any of the methods described herein and/or for embodying any of the apparatus features described herein.

The invention also provides a computer readable medium having stored thereon the computer program as aforesaid.

The invention also provides a signal carrying the computer pr g am as aforesaid, and a method of transmitting such a signal.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

The invention extends to methods and/or apparatus substantially as herein described with reference to the accompanying drawings.

The invention will now be described, purely by way of example, with reference to the accompanying drawings, in which:

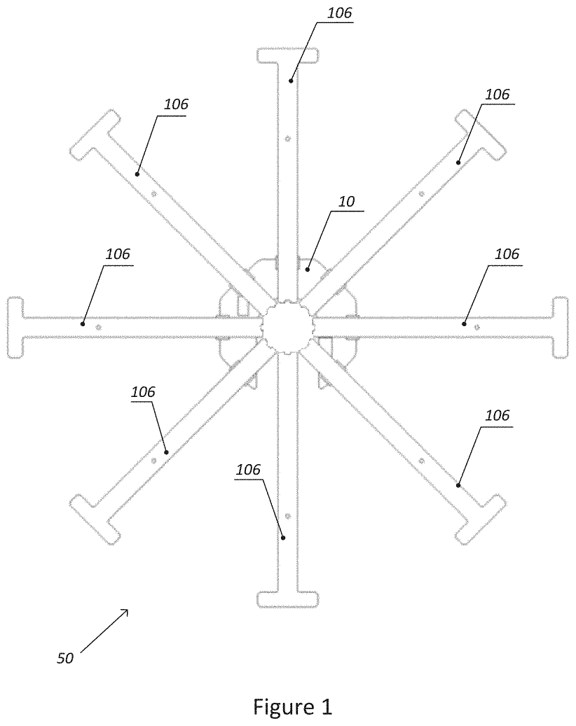

FIG. 1 shows a persistence of vision device adapted to be attached to a wheel;

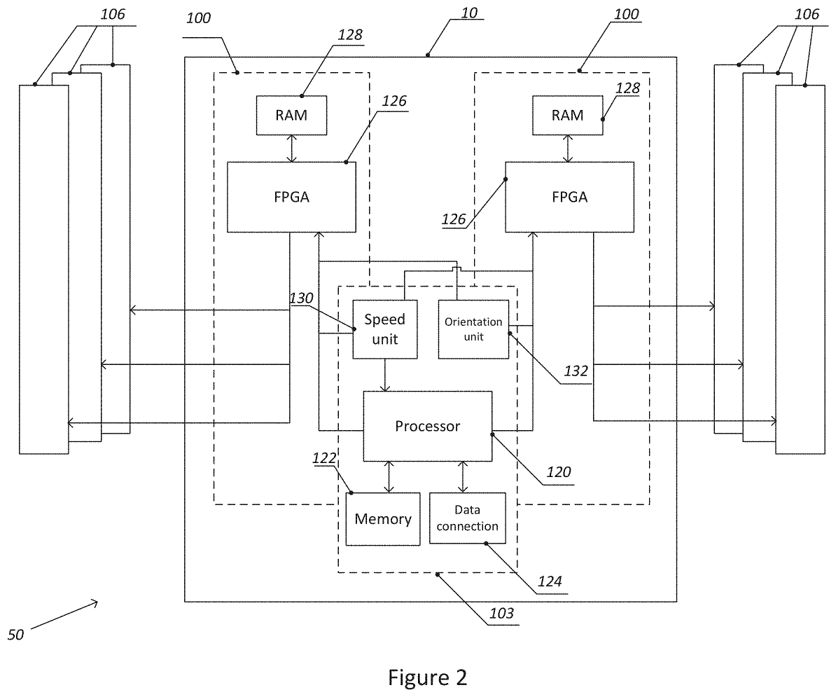

FIG. 2 is a schematic hardware diagram of a persistence of vision device;

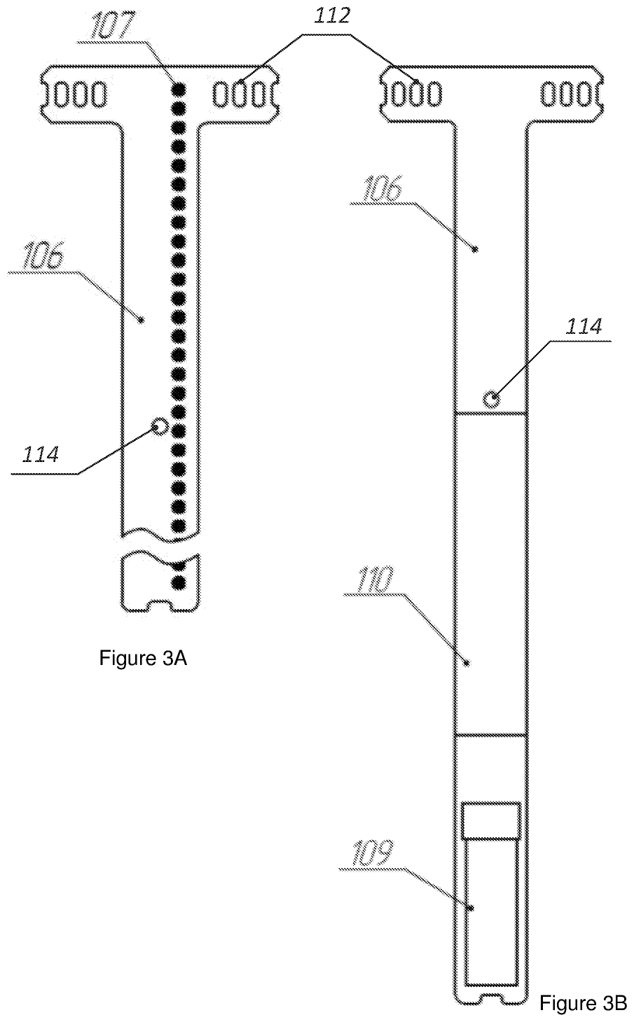

FIG. 3A shows a portion of one side of a light array;

FIG. 3B shows the opposing side of the light array shown in FIG. 3A;

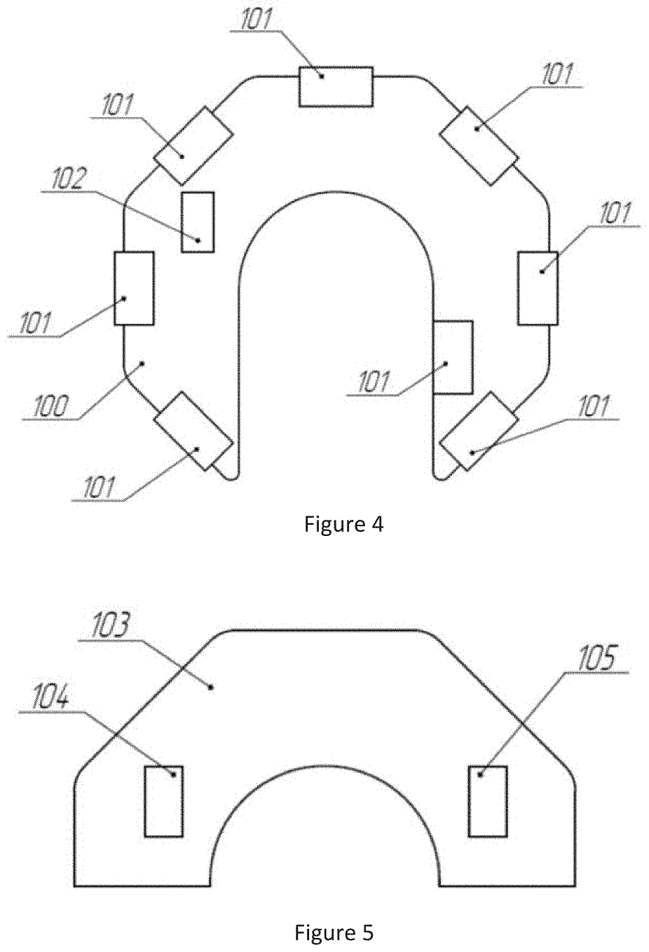

FIG. 4 shows a processing board;

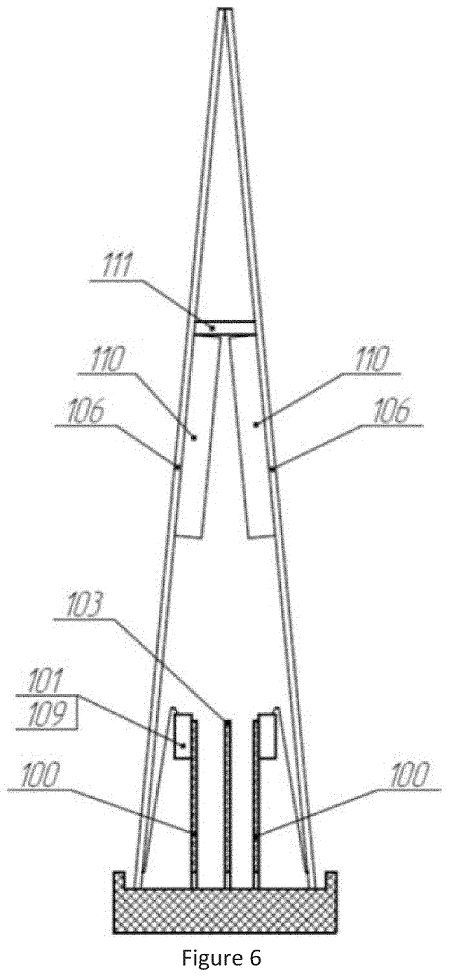

FIG. 5 shows a central control board;

FIG. 6 shows cross-sectional view of a portion of a wheel with a persistence of vision device attached thereto;

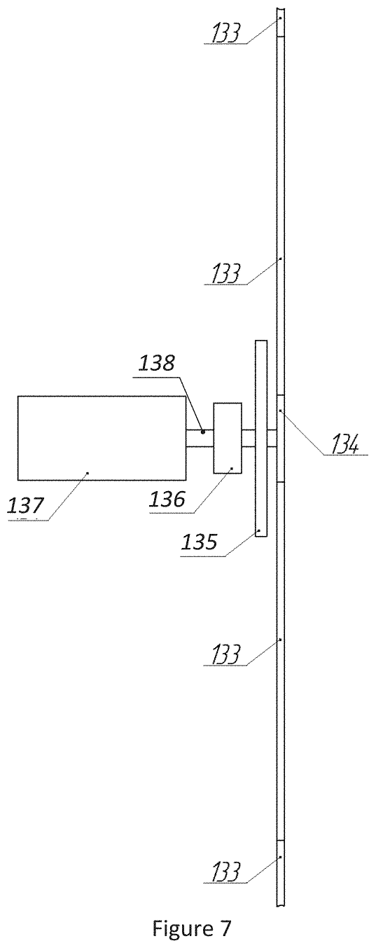

FIG. 7 shows a cross-sectional view of a persistence of vision device adapted to be rotated by a motor;

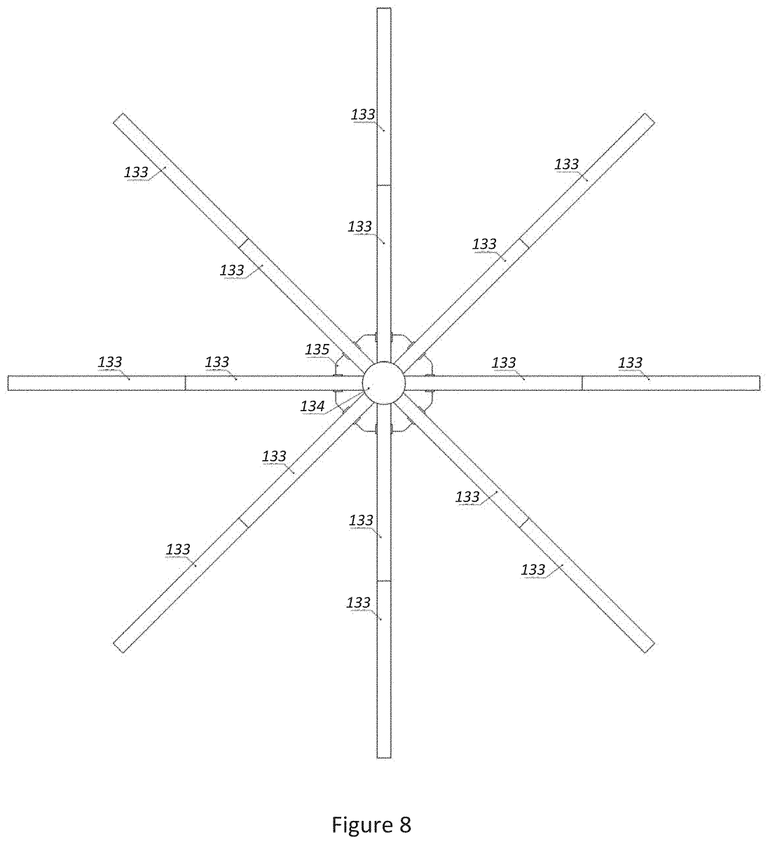

FIG. 8 shoes a front view of the persistence of vision device of FIG. 7;

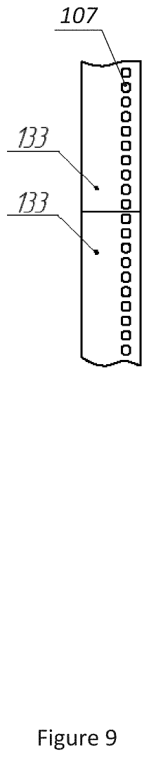

FIG. 9 shows an enlarged view of the connection between two light arrays;

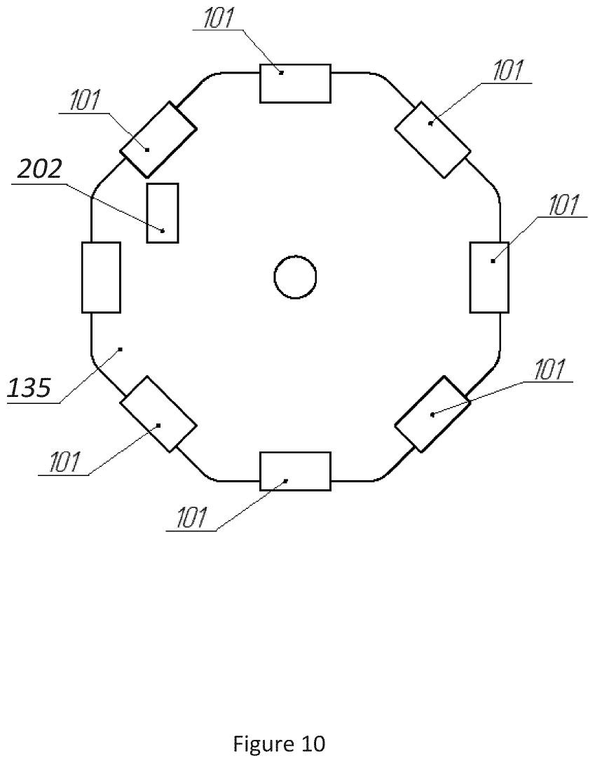

FIG. 10 shows a control board for the persistence of vision device of FIG. 7 or 8;

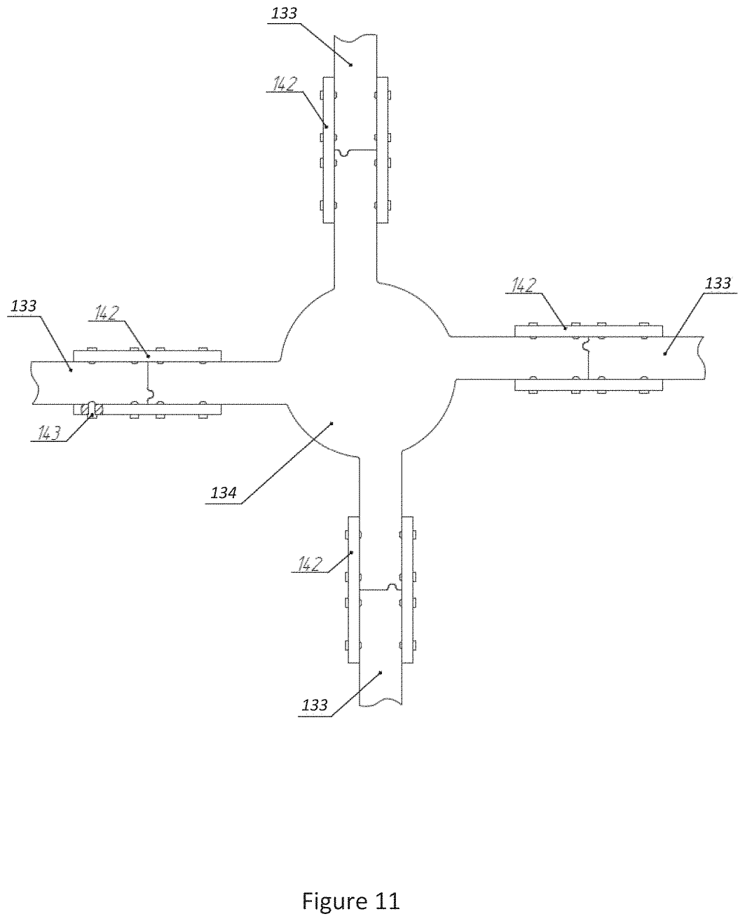

FIG. 11 shows an example central light array for the persistence of vision device of FIG. 7 or 8;

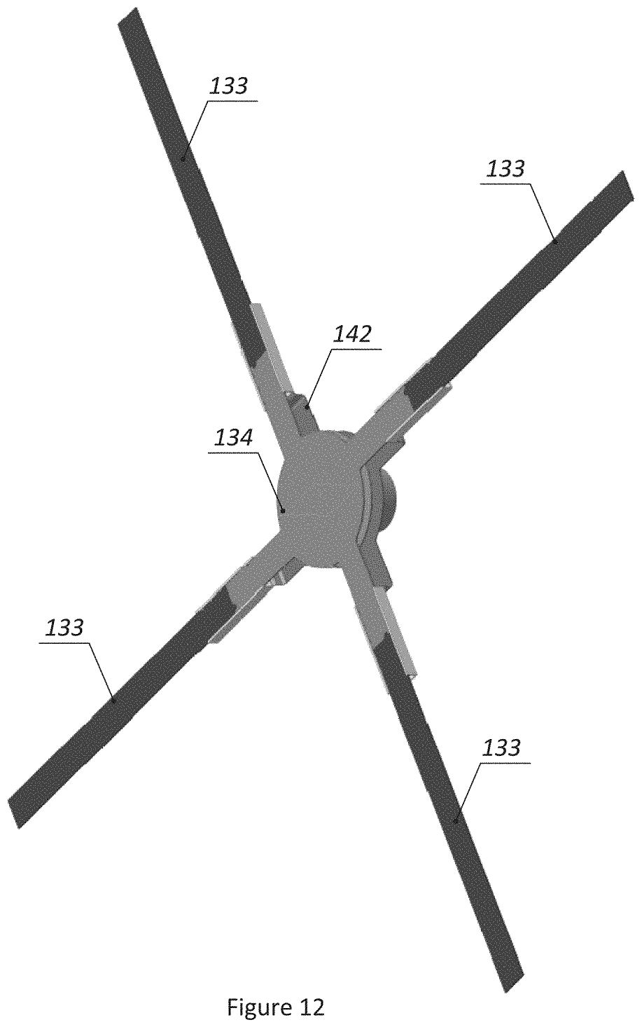

FIG. 12 shows a front perspective view of a persistence of vision device;

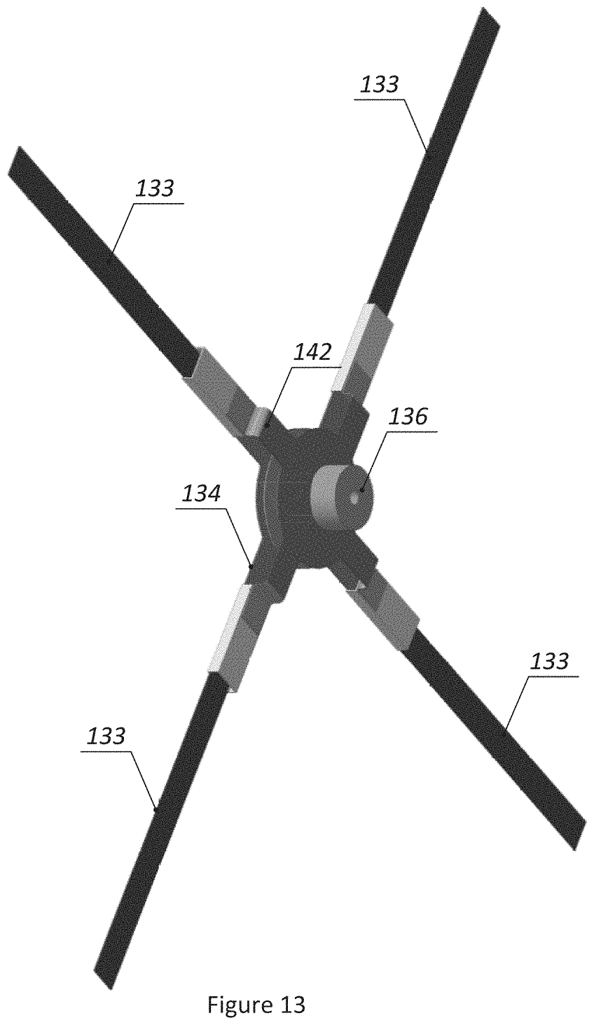

FIG. 13 shows a rear perspective view of a persistence of vision device;

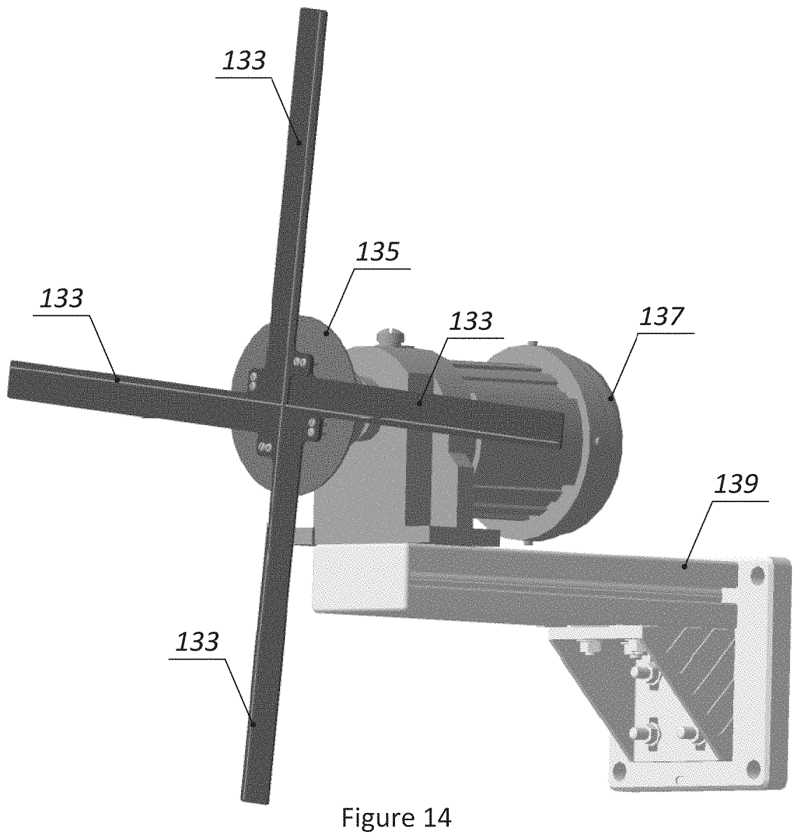

FIG. 14 shows a perspective view of an example persistence of vision device mounted on a motor; and

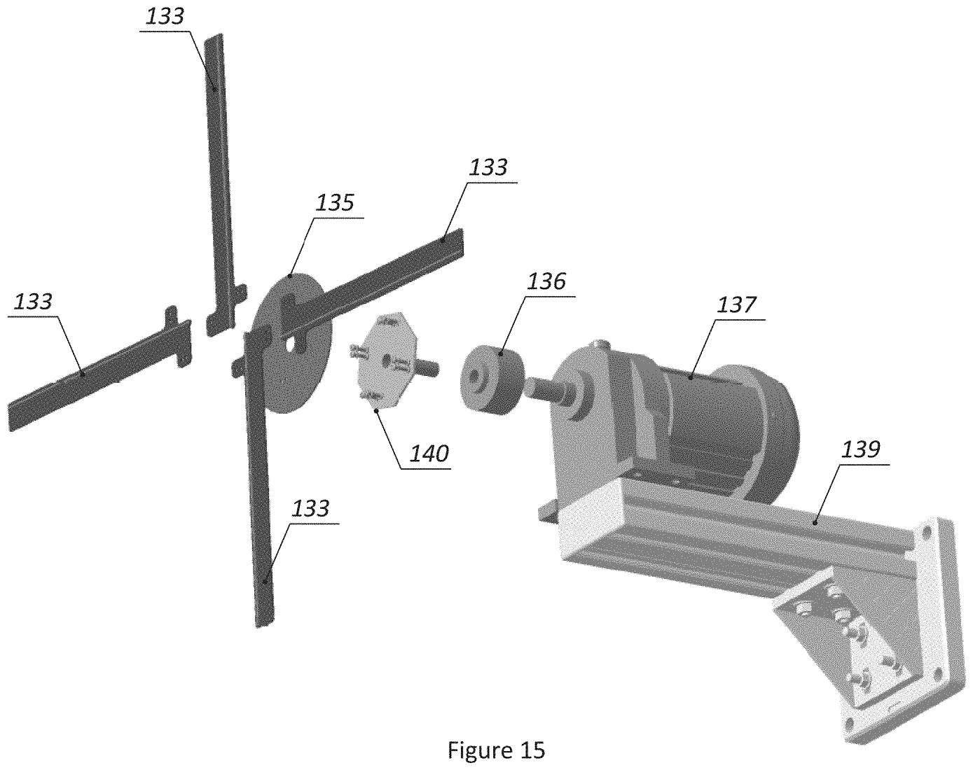

FIG. 15 shows an exploded perspective view of the persistence of vision device of FIG. 14.

### DETAILED DESCRIPTION

A persistence of vision device 50 adapted to be attached to a rotatable structure such as a wheel is shown in FIG. 1, The device comprises a plurality of equally spaced apart light array boards 106, and a processing unit 10. Further details relating to each of these separate components is provided below with reference to FIGS. 3A to 5.

In use, the processing unit 10 senses that the wheel is rotating via a magnetic sensor on the device 50 passing a magnet attached to a fixed part of the bicycle (for example, on the forks). Such a method of determining rotational speed is well-known in the art. In one embodiment, there is a magnetic sensor attached to one or more light arrays 106 and electrically connected to the processing unit 10. In another embodiment, there is a magnetic sensor attached to a spoke and electrically connected to the processing unit 10. In a further embodiment, there is a magnetic sensor attached to the processing unit 10 itself.

The processing unit 10 also senses the angle at which the device is positioned, for example by using an accelerometer to detect the orientation of the device 50 with respect to gravity. In another embodiment, the magnetic sensor on the device 50 passing a fixed magnet on the bicycle (or other non-rotating structure) can be used to determine the orientation of the device with respect to the fixed magnet. If there are multiple magnetic sensors on the device 50 (for example, on each light array 106) the orientation can be determined with greater precision. When employing such a method, the device 50 may need to be calibrated as the orientation of the display would depend on the angular position of the fixed magnetic element on the bicycle (e.g. the angle of the forks).

Using the orientation of each array 106 and speed of rotation (angular velocity) of the wheel, the processing unit 10 can determine the orientation of each light array 106 and activate illuminable elements (such as Light Emitting Diodes (LEDs)) on each array 106 accordingly so as to produce a persistence of vision display. Information regarding the orientation of the device may not be required if it is not critical that the image to be displayed has a particular orientation (for example, a circular pattern).

In one embodiment, there are two sets of light arrays 106 operable to be attached to opposing sides of a wheel, and the processing unit 10 comprises a central control board 103 which is operable to control the operation of all the light arrays 106 via two separate processing boards 100 (as shown schematically in FIG. 2).

FIG. 2 is a schematic hardware diagram of the device 50 where the processing unit 10 comprises a central control board 103 and two separate processing boards 100. The central control board 103 comprises a central processor 120, memory 122, a speed unit 130, an orientation unit 132, and a data connection 124. The speed unit 130 receives speed information (for example pulses of current from the magnetic sensor) and passes this information to the processor 120 which determines whether the rotational speed of the device 50 is above a pre-determined threshold (for example, corresponding to around 6 kilometres per hour) before activating the display. Similarly, the processor may deactivate the display when the rotational speed drops below a predetermined threshold (which, in one example, may also be around 6 kilometres per hour). The speed information from the speed unit 130 is also sent to each Field-Programmable Gate Array (FPGA) 126 which is operable to calculate the position of each array 106 in real time. In one example, the speed unit 130 comprises an Analogue-to-Digital Converter (ADC) and other appropriate circuitry to convert the detected ‘pulses’ into a digital signal suitable for processing by the processor 120 and each FPGA 126.

The orientation unit 132 receives signals (for example pulses of current from the magnetic sensor, or an output from an accelerometer) and passes this information to each FPGA 126 which determines the orientation of the device 50. Similarly, the orientation unit 132 may comprise an ADC and other suitable circuitry. In one embodiment, the same componentry is used for both the orientation unit 132 and the speed unit 130.

In use, data relating to at least one display pattern (such as images and/or videos) to be displayed by the device 50 and computer code adapted to cause said display pattern to be output for display is stored in memory 122. Before loading graphics onto the unit 50, the graphics are processed to correspond to the resolution of the screen, for example on software on a Personal Computer (PC) or smartphone. Alternatively, this processing may be performed by the processor 120. The graphics are preferably sent to the unit in ‘raw’ format and with a header identifying the display pattern, but may be provided to the unit in any format for further processing. The processor 120 fetches images to be displayed from memory 122 and sends them to the Random-Access Memory (RAM) 128 connected to the FPGA 126. The FPGA 126 then determines the speed and position of each light array 106 it controls (using the signal from the speed and/or orientation unit) and the corresponding pattern to be displayed in real-time to selectively activate the arrays 106 (or portions thereof) at predetermined times thereby to display the stored display pattern.

The FPGA 126 may be specifically configured depending on the type and/or number of arrays 106 it is operable to control. This dual (separate) control system, that is the provision of a central processor 120 coupled to one or more FPGAs 126, affords the advantage that the system can be modular, whereby additional/improved light arrays 106 can be added as and when required. Furthermore, splitting the processes of fetching the data relating to the display pattern (performed by the central processor 120) and activating the appropriate light arrays (performed by the FPGAs 126) allows for a much greater resolution of display to be produced relative to the capability of the central processor 120 operating alone. Each processing board 100 is shown to have a single FPGA 126, but multiple FPGAs 126 (or one board with a single FPGA 126) may be provided.

Information may be programmed into the memory 122 via data connection 124. This may be a wired connection (for example a Universal Serial Bus (USB) connection) so that a user can program the memory with specific images and/or video via a user interface on a personal computer. Alternatively, it may be a wireless link such as Bluetooth®, WiFi® or Near Field Communication,) and a mobile device (such as a smartphone or tablet) can be used to program the memory 122. This alternative may be particularly advantageous in situations where the type of information being displayed is required to be changed frequently, or away from a wired link. A wireless data connection may also be utilised to control the operation of the device 50, for example: switching between pre-stored images/video, altering the brightness/contrast of the display, turning the display on or off. Alternatively, or in addition, manual user input devices such as buttons, toggles or dials may be provided to perform these tasks. The device 50 may further comprise a Global Positioning System (GPS) unit so that specific devices can be remotely uploaded and controlled. Such devices may also be programmed to display location-based images, for example an advert for tourist services when near certain landmarks, or for local businesses.

The memory 122 is preferably non-volatile so that information stored in the memory 122 is not lost when the device 50 is not powered; examples of such non-volatile memory include Erasable Programmable Read-Only Memory (EPROM), Electrically Erasable Programmable Read-Only Memory (EEPROM), or Flash memory (which is preferable).

FIG. 3A shows a front view and FIG. 3B shows a back view of the light array boards 106. Each light array board 106 has at least one row of illuminable elements 107 on its outer-facing face; preferably, these are LEDs, more preferably, multi-colour LEDs. The spacing of the illuminable elements 107 along the entire length of the array allows for an image to fill the maximum area within a wheel. The distance between each individual illuminable element 107 and the absolute dimension of the elements determine the maximum achievable resolution. The variety in colour operable to be displayed is also limited by the density of illuminable elements 107, and the number of individual colours each illuminable element 107 can display. Therefore, it is advantageous to have as many illuminable elements 107 as possible on each array to enable a large, high-resolution image to be displayed. In one embodiment, more than 32 LEDs 107 are provided, each operable to emit 24 bit colour light. Preferably between 32 and 128, more preferably 96 LEDs 107 are provided. The use of FPGAs 126 with individual electrical conductive pathways to each light array 106 (or group of LEDs 107) minimises the processing required to control a large number of individual illuminable elements 107, thus allowing a high quality image to be displayed with low latency.

As can be seen from FIG. 1, the light arrays 106 are separately and independently connected to the processing unit 10 thus forming a ‘star’ shape network around the processing unit. This network is afforded by connectors 109 connecting with corresponding connectors 101 provided on the processing board 100 of the processing unit 10 (see FIG. 4). These connections 109 are operable to electrically connect the light array 106 to the processing unit 10. This connection may be in the form of a cable (e.g. a ribbon cable) or a more rigid connection which also enables a mechanical connection between the light array 106 and the processing unit 10. In this way, the whole device will not fail if a particular light array 106 fails.

The light arrays 106 are also operable to be mechanically connected to spokes of a wheel and/or a further light array 106 on an opposite face of the wheel (see FIG. 6) via a plurality of apertures 112 at the distal end from the wheel hub. These apertures are arranged in a transverse direction to the length of the array, forming a ‘T’ shape. This arrangement allows flexibility in the positioning of the array 106 so as to enable connection to a wide variety of wheels which may have different spoke numbers/patterns.

There may be further apertures 114 provided along the length of the light array 106 so as to further secure the light array 106 to the spoke and/or another light array 106 on an opposite face of the wheel. The light arrays 106 are thereby adapted to be secured to a wheel.

A battery 110 is also provided on the inward-facing face of each light array 106. This is provided towards the proximal end (adjacent the wheel hub) so as to minimise the angular momentum of the device, which would otherwise negatively impact on braking performance and the security of fastening. Each light array 106 may be provided with its own battery, or alternatively may share a battery with a light array 106 on the opposing side of the device by way of an electrical connection. In one embodiment, there is a separate battery for every pair of light arrays 106, and another battery on the processing unit 10, When connected together they operate in parallel, effectively forming one power source for the entire device 50. These batteries may be charged separately or in parallel. Charging separately may be safer as different batteries may have different levels of charge. Any type of battery of a suitable size/capacity may be used, for example AA batteries.

Alternatively, a central battery may be provided so as to power all of the light arrays and the processing unit.

Alternatively, an external power supply may be used. If the device 50 is provided on a bicycle, a dynamo may be used to power the device when the bicycle is moving. If the device 50 is provided on a stationary bicycle or other rotating device, a mains power supply may be employed.

Each light array 106 is a ‘standalone’ element of the system afforded by separate, independent connections between each light array 106 and the processing unit 10. Each light array's inclusion into or exclusion from the system 50 has no impact on the operation of any other part of the device 50; if one light array 106 fails it does not impact on the operation of any other part of the device 50.

FIG. 4 is a diagram showing the shape of a processing board 100 and the connections provided on the board. The processing board 100 is shaped like a ‘horseshoe’ so as to fit around a hub of a bicycle wheel. The perimeter of the board 100 is broadly in the shape of a regular octagon, with one side missing so as to enable the board to be placed around the hub. On each side there is a connector 101 for coupling with a corresponding connector 109 of a light array 106. The connector 101 corresponding to the ‘missing’ side of the octagon is provided on the inside of the horseshoe. The light array 106 operable to be connected to this connector 101 may be provided with a connector positioned at a different angle. Alternatively, all light arrays 106 could be provided with an adjustable connector whose angle can be adjusted, and then fixed in place so that any array could be connected to this connector 101. This adjustably is required in the case where the arrays are mechanically secured to the processing board 100 via the connectors 101. In one embodiment, each processing board 100 comprises at least one FPGA 126 and associated RAM 128, as described above with reference to FIG. 2.

The board 100 having the shape of a regular octagon provides the advantage that each light array 106 is spaced at an equal angle from its neighbours. Other regular polygons having a different number of sides (and hence light arrays 106) are equally possible. The more light arrays 106 that are provided reduce the minimum speed is that is required to achieve persistence of vision; however, space restraints limit the number achievable within the confines of a bicycle wheel.

In the embodiment in which a single processing board 100 is utilised, connectors 101 are provided on both faces of the board 100 so that sixteen light arrays 106 can be electrically connected to the same board 100.

A further connector 102 is provided to mechanically and electrically connect the processing board 100 to the control board 103.

FIG. 5 is a diagram showing the shape of the control board 103 and the connections provided on the board 103. The control board 103 conforms to the same shape as the processing board 100. This is so as to maintain the same profile as the processing board 100 and provide an attachment surface. The shape is shown as a half-octagon, but it may equally fully conform to the full octagon, horseshoe shape of the processing board 100. The latter may be preferable if distribution of weight around the hub is important, but the former would be preferable if reducing overall weight and complexity is important. In one embodiment, the control board 103 comprises the central processor 120 and memory 122, as described above with reference to FIG. 2.

There may be apertures provided, for example for straps or ties to secure the processing board(s) 100 and the control board 103 to the hub of a wheel. The mechanical connections between the boards 100, 103, the light arrays 106 and the spokes result in a device 50 which forms a single rigid unit. If the device 50 is not rigid, vibrations and shocks may result in a connection (mechanical or electrical) being severed which would have a negative impact on the performance of the device 50.

FIG. 6 shows a schematic cross-section through a wheel on which a persistence of vision device 50 is attached. The control board 103 is positioned at the center of the arrangement, around the hub, while the processing boards 100 are positioned either side of the control board 103. These boards are mechanically and electrically connected via board-to-board connections 102, 104 and 105 (see FIGS. 4 and 5). The first set of eight light array boards 106 is attached to the spokes on one side of the wheel; each light array board 106 from the set is separately connected to the first processing unit 100 on the same side of the wheel. The second set of eight light array boards is attached to the spokes on the opposite face of the wheel; each light array board from the set is separately connected to the second processing board 100. Such a configuration with light array boards 106 on opposite faces of the wheel allows the space between the spokes to be kept free from obstructions so that the processing boards 100 and the control board 103 may be situated between the spokes.

A connector 111 is provided to mechanically connect each light array 106 to the corresponding light array 106 on the opposite side of the wheel through aperture 114 (FIGS. 3A, 3B). This makes the device more rigid and affords greater security of fastening. In one example, the connector 111 is in the form of a cable-tie. In the example where a power source is shared by light arrays 106 on opposing sides of the wheel, an electrical connection is also provided.

The device 50 may be situated inside the spokes of the wheel so that the spokes protect the device 50 from external contact. Alternatively, the light arrays 106 and/or the processing unit 10 may be positioned outside of the spokes so as to enable easy access.

In one advantageous use of the device 50 described above, advertising may be displayed on a rotating device such as a bicycle wheel (or on a display apparatus). The resolution and depth of colour afforded by the various features of the device 50 allows high quality images or videos to be displayed, creating a visually attractive display which catches the eye of potential customers. Furthermore, the device 50 described is operable to display high resolution images/videos at low rotational speeds, meaning that it is possible for even a slow-moving bicycle to display advertising messages; such messages are more likely to be noticed and comprehended by a stationary observer.

FIGS. 7-10 show an alternative embodiment whereby a motor is provided which rotates a number of light arrays which are not necessarily affixed to an external structure. This produces the visually impressive effect of the displayed image appearing transparent—the image seemingly ‘floating’ in the air. Furthermore, the size of the display is not limited by the size of an external structure (such as a bicycle wheel). The present embodiment which is not necessarily affixed to an external structure may comprise some or all features from the above embodiment which is described affixed to a rotatable structure such as a wheel. For example, the control board 135 may share some or all of the features or components as the control board 10 as shown in FIG. 2. The light arrays 133 may also share some or all of the features or components as the light arrays 106 described above.

FIG. 7 shows a side view of a persistence of vision device adapted to produce a transparent image. The device comprises a motor 137, a slip ring 136, a control board 135, a number of light arrays 133 and a central light array 134. The light arrays 133 and the central light array 134 are independently electrically connected to the control unit 135, which is in turn connected to an axle 138. In use, the motor 137 rotates the axle 138 which rotates the control board 135 and light arrays 133, 134. The motor may drive the axle directly, or it may rotate the device by way of switching electromagnets (for example). In one example, the control board 135 and light arrays 133, 134 are powered via an external power source (not shown) via a slip ring 136 on the axle 138. This eliminates the need for batteries or other power sources to be affixed to the moving part of the display device which improves the production of a transparent image.

FIG. 8 shows a front-on view of the persistence of vision device adapted to produce a transparent image as shown in FIG. 7. In the embodiment shown there are eight arms of light arrays, each arm comprising two separate light arrays 133 which are longitudinally mechanically connected together, but independently electrically connected to the control unit 135. The use of such ‘composite’ arms reduces processing demands—individual electrical conductive pathways to each light array 133 minimises the processing required to control a large number of individual illuminable elements 107, thus allowing a high quality image to be displayed with low latency. In an alternative example, a number of illuminable elements 107 on a light array 133 may be grouped together and separately electrically connected to the control unit 135. The light arrays 133 are stiff so as to not necessarily require any external support, a transparent casing may be provided over each light array 133 so as to provide additional support and/or protection.

An additional, circular (or otherwise) shaped light array 134 is provided around the center of rotation of the device; this allows the image produced to extend all the way to the center of the device thereby producing a more realistic ‘floating’ image without a ‘hole’ in the center of the image. This further array 134 is independently electrically connected to the control unit 135, or may form part of another light array 133—thereby making one array 133 a ‘master array’. The size of the hole depends primarily on the number of LED arrays 133 and the width of the LED arrays 133. For large displays more LED arrays 133 might be required to lower the RPM of the structure, yielding a bigger hole in the middle. Alternatively or additionally, the arrays 133 may be fashioned so as to tessellate in the center, thereby allowing each array 133 to extend substantially to the center of rotation of the device.

The light arrays 133 may be double-sided so that an image is displayed on both sides. In one embodiment the light arrays are substantially transparent so as to improve the transparency of the displayed image.

It may not be necessary to have a speed unit (130—see FIG. 2) attached to the device as the speed of rotation is controlled by a motor; the speed of rotation can therefore be accurately determined directly from the amount of power being supplied to the motor (following calibration). It may however be necessary to determine the orientation of the device, for example if the image to be displayed is required to be of a particular orientation. Determining the orientation of the device could be performed in any manner described above (for example using magnets and/or accelerometers) or from the relative orientation of the motor and axle/device.

FIG. 9 shows an enlarged section of the connection between two light arrays 133. The illuminable elements 107 form a linear array either side of the connection. The size of the display is not restrained by the size of a wheel, rather on mechanical and processing constraints. The amount of processed/transferred information per unit time depends on angular velocity of the structure, length of LED arrays 133, on absolute dimensions of the LEDs and the number of LEDs 107. The size of each array 133 is determined by manufacturing size limitations of Printed Circuit Boards (PCBs).

FIG. 10 shows the control unit 135 for the persistence of vision device adapted to produce a transparent image. This control unit differs from that shown in FIG. 4 in that it is not a ‘horseshoe’ shape, as there is no need for it to fit around the hub of a bicycle. In one embodiment only one board is provided, with the processing performed externally to the rotating structure. A power and data connection 202 is provided on the control unit to receive power and instructions via the slip ring 136 (see FIG. 7). Instructions and/or power may be transmitted wirelessly to the device. The control unit 135 may alternatively have on-board processing such as one or more FPGAs 126 and RAM 128 (see FIG. 2).

FIG. 11 shows an example central light array 134 which, in the embodiment shown is mechanically connected to other light arrays 133 and supported by frame 142. The central light array 134 conforms to the shape of the persistence of vision device (in the example shown, this is a ‘spoked’ arrangement with the same number of arms as there are light arrays 133)—such an arrangement reduces the amount of the device which does not contain light emitting elements, thereby producing a more complete image,

FIG. 12 shows a front perspective view of a complete persistence of vision device showing the central light array 134, light arrays 133 and the frame 142 supporting them.

FIG. 13 shows a rear perspective view of the persistence of vision device shown in FIG. 12 showing a slip ring 136 for connection to an axle for rotation (for example by a motor).

FIG. 14 shows an alternative embodiment where no central light array 134 is provided, rather the light arrays 133 tessellate in the centre so as to allow the image produced to extend all the way to the center of the device. In the example shown, the persistence of vision device is connected to a motor 137 mounted on a frame 139.

FIG. 15 shows an exploded perspective view of the components of the persistence of vision device shown in FIG. 14. Additional components such as the control board 135, slip ring 136 and axle-board connector 140 can be seen.

### Alternatives and Modifications

Various other modifications will be apparent to those skilled in the art for example information relating to the speed of rotation may be derived from external devices such as other speed sensors on a bicycle.

The connectors 101, 102, 104, 105 and 109 are referred to above as providing a mechanical and electrical connection between two components of the device 50. In an alternative embodiment, these elements only supply one of these types of connection, the other being provided by a separate element.

The above description refers to ‘Field Programmable Gate Arrays’ 126 as being used to control the operation of the light arrays 106 in real-time, but other computational modules may equally be used such as Application Specific Integrated Circuits (ASICs), or Complex Programmable Logic Devices (CPLDs).

Instead of having two sets of light arrays 106 on either side of the wheel, one set could be provided with lights on the front and back face of each light array 106..

The above description refers to a particular embodiment where there are two processing boards 100 and a separate control board 103; in other embodiments, two or more of these boards may be combined. For example both processing boards 100 may be combined into one (potentially having a single FPGA), or the functionality of the central board 103 may be incorporated into one of the processing boards 100, or there could be just one board corresponding to the entire processing unit 10.

Further, the boards 100, 103 may not necessarily each be in the shape of a horseshoe, Although this is advantageous in securing the boards around the hub, other shapes such as a ‘V’ shape, or a segment of a circle (e.g. a ‘Pac-Man’ shape), are equally possible.

It will be understood that the present invention has been described above purely by way of example, and modifications of detail can be made within the scope of the invention.

Reference numerals appearing in the claims are by way of illustration only and shall have no limiting effect on the scope of the claims.

1. A persistence of vision display, comprising:
a plurality of light arrays independently electrically coupled to a processing unit and mechanically coupled to a wheel; and
the processing unit configured to send control information and data to each light array of the plurality of light arrays to determine an output of each light array of the plurality of light arrays, wherein the processing unit is adapted to a shape of the wheel and comprises:
a real-time computation unit configured to control an operation of each light array of the plurality of light arrays in real-time; and
one or more sensors on one or more of the plurality of light arrays, wherein the one or more sensors are configured to:
detect an orientation of the one or more of the plurality of light arrays; and
send the orientation information to the processing unit.

2. The display of claim 1, wherein the plurality of light arrays is further configured to:
generate a persistence of vision image or video using rotational movement of the wheel.

3. The display of claim 1, wherein:
each light array of the plurality of light arrays is further configured to be mechanically coupled to the processing unit; or
each light array of the plurality of light arrays is electrically coupled to a power source and configured to share the power source with a different light array; or
each light array of the plurality of light arrays comprises two or more groups of illuminable elements, wherein each group of the two or more groups is independently electrically coupled to the processing unit; or
each light array of the plurality of light arrays is shaped to tessellate at a center of rotation of the plurality of light arrays.

4. The display of claim 1, wherein:
the one or more sensors comprise a speed unit configured to detect a speed of rotation of the one or more of the plurality of light arrays;
the one or more sensors include one or more magnetic sensors on the processing unit of on the one or more of the plurality of light arrays;
the speed unit is further configured to send a speed of rotation information of the plurality of light arrays to the processing unit; and
the processing unit is further configured to determine an angular speed of the plurality of light arrays.

5. The display of claim 1, wherein the processing unit is horseshoe-shaped, star-shaped, cross-shaped, or has an irregular round shape.

6. A system for a persistence of vision display, comprising:
a plurality of light arrays independently electrically coupled to a processing unit and mechanically coupled to a rotatable structure; and
the processing unit configured to send control information and data to each light array of the plurality of light arrays to determine an output of each light array of the plurality of light arrays, wherein the processing unit is physically adapted to dimensions of the rotatable structure and comprises:
a real-time computation unit configured to control an operation of each light array of the plurality of light arrays in real-time; and
one or more sensors on one or more of the plurality of light arrays, wherein the one or more sensors are configured to:
detect an orientation of the one or more of the plurality of light arrays; and
send the orientation information to the processing unit.

7. The system of claim 6, wherein the plurality of light arrays is further configured to:
generate a persistence of vision image or video using rotational movement.

8. The system of claim 6, wherein each light array of the plurality of light arrays is further configured to be mechanically coupled to the processing unit.

9. The system of claim 6, wherein each light array of the plurality of light arrays is electrically coupled to a power source and configured to share the power source with a different light array.

10. The system of claim 6, wherein the one or more sensors comprise a speed unit configured to detect a speed of rotation of the one or more of the plurality of light arrays.

11. The system of claim 10, wherein the one or more sensors include one or more magnetic sensors on the processing unit.

12. The system of claim 10, wherein the one or more sensors include one or more magnetic sensors on the one or more of the plurality of light arrays.

13. The system of claim 10, wherein:
the speed unit is further configured to send a speed of rotation information of the plurality of light arrays to the processing unit; and
the processing unit is further configured to determine an angular speed of the plurality of light arrays.

14. The system of claim 6, wherein the one or more sensors includes an accelerometer mechanically coupled to the processing unit to determine the orientation of the one or more of the plurality of light arrays.

15. The system of claim 6, wherein the processing unit comprises a separate control board including a central processor and at least one processing board with a mounted computational module.

16. The system of claim 6, wherein the processing unit comprises two processing boards, wherein each of the two processing boards includes a real-time computation unit.

17. The system of claim 16, wherein each of the two processing boards is configured to control a plurality of light arrays.

18. The system of claim 16, wherein a separate control board is configured to be mechanically coupled to and positioned between the two processing boards.

19. The system of claim 6, further comprising a motor configured to rotate one or more of the plurality of light arrays.

20. The system of claim 6, further comprising a slip ring configured to provide power to one or more of the plurality of light arrays.

21. The system of claim 6, further comprising a slip ring configured to provide control information to one or more of the plurality of light arrays.

22. The system of claim 6, wherein each light array of the plurality of light arrays comprises two or more groups of illuminable elements, wherein each group of the two or more groups is independently electrically coupled to the processing unit.

23. The system of claim 22, wherein each group of the two or more groups corresponds to a longitudinally coupled light array.

24. The system of claim 6, further comprising a light array physically adapted around a center of rotation of the rotatable structure.

25. The system of claim 24, wherein the light array that is physically adapted around a center of rotation of the rotatable structure is adapted to be mechanically coupled to the plurality of light arrays.

26. The system of claim 24, wherein the light array physically adapted around a center of rotation of the rotatable structure is physically adapted to the shape of the system.

27. The system of claim 24, wherein the light array physically adapted around a center of rotation of the rotatable structure includes a same number of arms as the number of the plurality of light arrays.

28. The system of claim 6, wherein each light array of the plurality of light arrays is shaped to tessellate at a center of rotation of the plurality of light arrays.

29. The system of claim 6, wherein the rotatable structure comprises a plurality of arms, wherein each arm comprises a light array of the plurality of light arrays.

30. The system of claim 6, wherein the rotatable structure comprises one or more of: a wheel or a circle of a rigid form.

31. The system of claim 6, wherein the processing unit is horseshoe-shaped, star-shaped, cross-shaped, or has an irregular round shape.
